(19) United States
(12) Patent Application Publication
(10) Pub. No.: US 2016/0037590 A1
(43) Pub. Date: Feb. 4, 2016

(54) SYSTEM AND METHOD FOR USING ELECTROMAGNETIC ENERGY IN A PROPULSION SYSTEM

(71) Applicant: ESCAPE DYNAMICS, INC.,, Broomfield, CO (US)

(72) Inventors: Dmitriy Tseliakhovich, Broomfield, CO (US); Matthew Loukas Hanover, Denver, CO (US)

(21) Appl. No.: 14/160,057

(22) Filed: Jan. 21, 2014

Related U.S. Application Data
(60) Provisional application No. 61/754,811, filed on Jan. 21, 2013.

(51) Int. Cl. H05B 6/80; H05B 6/78; H05B 6/64

(52) U.S. Cl. CPC H05B 6/802; H05B 6/6482; H05B 6/78; H05B 2206/04

(57) ABSTRACT

A system for receiving energy from an electromagnetic energy beam, and for transferring the received energy to a working fluid as thermal energy, comprises a heat exchanger body that defines a path for the working fluid. The heat exchanger body comprising a ceramic matrix composite (CMC) material. A method for configuring a heat exchanger for receiving energy from an electromagnetic energy beam, and for transferring the received energy to a working fluid as thermal energy, includes providing a heat exchanger body, the heat exchanger body comprising a ceramic matrix composite (CMC) material, the CMC material comprising a SiC matrix. The method also includes introducing a concentration of dopant into the SiC matrix, wherein the dopant is selected to facilitate absorption of energy from the electromagnetic energy beam, and wherein the concentration is suitable to achieve a desired rate of energy absorption from the electromagnetic energy beam.

### CROSS-REFERENCES TO RELATED APPLICATIONS

This patent application claims priority to U.S. Provisional Patent Application Ser. No. 61/754,811 filed Jan. 21, 2013, which is incorporated herein by reference in its entirety.

### BACKGROUND OF THE INVENTION

The present invention relates to systems and methods for receiving energy transmitted from a remote source via an electromagnetic beam and using the received energy to perform useful work and more particularly to an improved apparatus for receiving a beam of electromagnetic energy and transferring the received electromagnetic energy to a working fluid as thermal energy.

Energy may be transferred from a remote location to a receiver via a beam of electromagnetic energy. The receiver may include a heat exchanger configured to absorb energy from the incoming electromagnetic beam (i.e., the incoming radiation) and to transfer the absorbed energy to a working fluid in the form of thermal energy. The absorption of the energy may cause an increase in a temperature of the working fluid. The working fluid may then be used to perform useful work, such as by driving a turbine or by generating thrust. It is anticipated, for example, that a beam of electromagnetic energy may be used to power a vehicle, such as a spacecraft, through its application to an external microwave propulsion thruster.

To facilitate such uses of beamed electromagnetic energy, it is desirable that the receiving apparatus be capable of absorbing electromagnetic energy from the incoming beam and transferring the energy to a working fluid in a reasonably efficient manner. It should be understood that a beam of electromagnetic energy may comprise electromagnetic energy having one or more characteristic wavelengths (e.g., microwave energy). Therefore, in addition to being relatively light in weight, mechanically robust, chemically stable, and thermally conductive, it would be advantageous for the receiving apparatus to be capable of and suitable for absorbing microwave energy. Unfortunately, this combination of properties has heretofore proven to pose significant challenges to designers of propulsion systems.

For example, while some ceramic materials, such as SiC, may be adaptable advantageously for absorbing energy received from an incoming transmission of electromagnetic radiation (e.g., a beam of microwave energy), such materials may have other inherent properties that render the materials unsuitable for use in space vehicle applications. For example, some SiC materials may be relatively brittle and may have limited chemical stability in oxidative environments. For example, some SiC materials may become unstable in the presence of oxygen at temperatures greater than 1650 C. As a result, such limitations on the operating temperatures of components comprising SiC can render them impractical for propulsion systems.

In addition, electromagnetic properties of certain ceramic materials may be highly dependent upon their operating temperature. For example, some ceramic materials exhibit significant changes in their abilities to absorb and/or reflect incoming transmissions of electromagnetic energy (e.g., microwave energy beams) as an operating temperature of the material changes. In extreme cases, a ceramic material may transition from a first state, in which the material is highly absorptive to incoming transmissions of energy, to a second state, in which the material is highly reflective of incoming transmissions of energy, and the transitioning between the first and the second states is dependent upon an operating temperature of the ceramic material. As a result, components constructed from monolithic ceramic materials may not be well-suited (i.e., may be relatively inefficient, unstable, or unreliable, may not be durable, etc.) for the purpose of receiving and absorbing energy from an electromagnetic beam and transferring the received and absorbed energy to a working fluid (or to be applied in a desired way to a targeted recipient) as thermal energy.

Accordingly, it is desirable to have an improved system and method for receiving energy from an electromagnetic energy beam and for transferring the received energy to a working fluid or another targeted recipient as thermal energy.

### SUMMARY OF THE INVENTION

In an exemplary embodiment, a system for receiving energy from an electromagnetic energy beam, and for transferring the received energy to a working fluid as thermal energy, comprises a heat exchanger body that defines a path for the working fluid. The heat exchanger body comprises a ceramic matrix composite (CMC) material.

In another aspect, an exemplary method for configuring a heat exchanger for receiving energy from an electromagnetic energy beam, and for transferring the received energy to a working fluid as thermal energy, includes providing a heat exchanger body that defines a path for the working fluid, the heat exchanger body comprising a ceramic matrix composite (CMC) material, the CMC material comprising a SiC matrix. The method also includes introducing a concentration of dopant (e.g., vanadium) into the SiC matrix, wherein the dopant is selected to facilitate absorption of energy from the electromagnetic energy beam, and wherein the concentration of dopant is configured so as to enable the material to achieve a desired rate of energy absorption from the electromagnetic energy beam.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a diagrammatic view of an external energy transfer system with an emitter and a receiver;

FIG. 2 shows an exemplary embodiment of the heat exchanger for efficient utilization of external electromagnetic energy;

FIG. 3 shows an exemplary relationship between local temperature and position along the path of the working fluid within an exemplary heat exchanger;

FIG. 4 shows exemplary relationships between energy absorption and position along the path of the working fluid within an exemplary heat exchanger;

FIG. 5 shows an exemplary heat exchanger; and

FIG. 6 shows a view of an exemplary heat exchanger comprising a plurality of tiles arranged in a matrix configuration.

### DETAILED DESCRIPTION

The following description is merely exemplary in nature and is not intended to limit the present disclosure, its application or uses. It should be understood that throughout the drawings, corresponding reference numerals indicate like or corresponding parts and features.

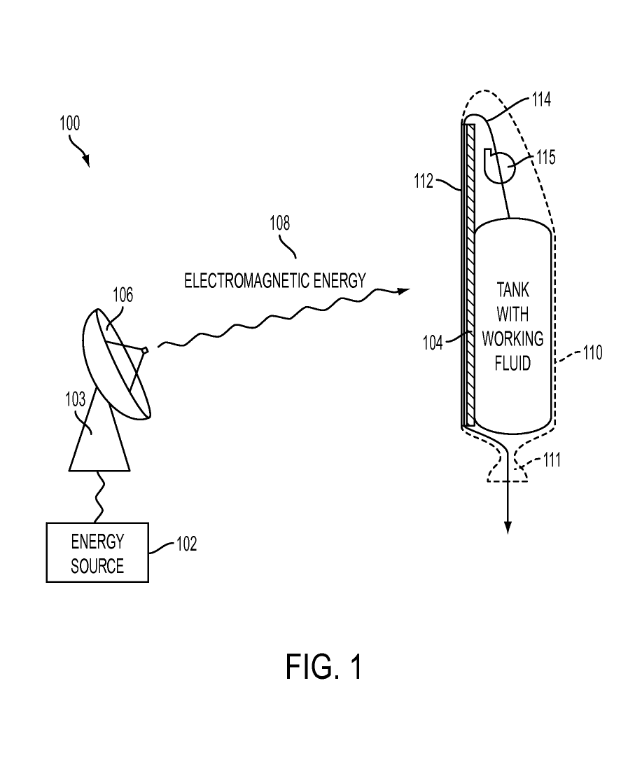

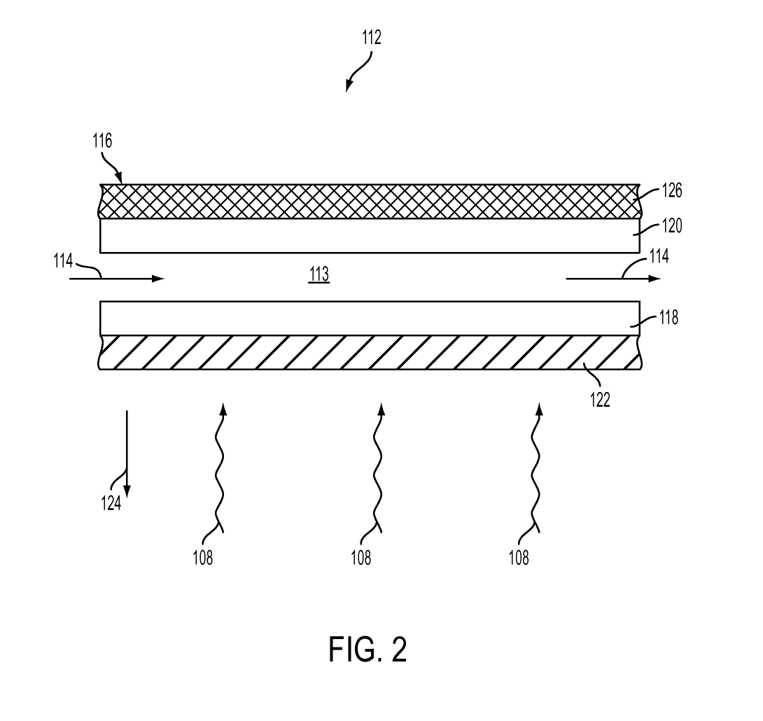

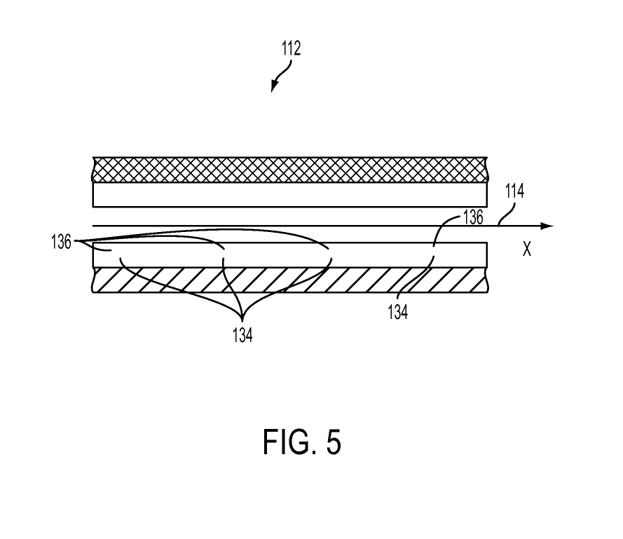

Referring now to the Figures, where the invention will be described with reference to specific embodiments, without limiting same, FIG. 1 is a diagrammatic view of an external energy transfer system with an emitter and a receiver, FIG. 2 shows an exemplary embodiment of the heat exchanger for efficient utilization of external electromagnetic energy, and FIG. 5 shows an exemplary heat exchanger 112. As shown in FIG. 1, FIG. 2, and FIG. 5, an exemplary external energy transfer system 100 includes a remote source 102 of energy. In an exemplary embodiment, the remote source 102 is coupled to a transmitter 103 that is configured for transmitting a beam of electromagnetic energy (e.g., a beam of microwave energy) toward an energy beam receiver 104. The transmitter 103 includes an energy beam concentrator 106 that is configured and arranged for: (1) receiving electromagnetic energy from the remote source 102; (2) aggregating the electromagnetic energy received from the remote source 102 so as to form a focused energy beam 108; and (3) directing the focused energy beam 108 toward the energy beam receiver 104.

In an exemplary embodiment, the energy beam concentrator 106 comprises an antenna configured for receiving electromagnetic energy having a predefined set of characteristics, such as those of microwave energy. The energy beam concentrator 106 may also comprise a set of antennas that form a phased array configured for selectively receiving the focused energy beam 108. The energy beam receiver 104 may be stationary (e.g., ground-based), and may be positioned remotely from the transmitter 103. In an exemplary embodiment, the energy beam receiver 104 is carried on a vehicle 110, which may be moving or may be temporarily disposed in a stationary position. The vehicle 110 may be a land or sea-based vehicle or may be a flying vehicle such as an aircraft, a launch vehicle, a satellite, or a spacecraft.

In an exemplary embodiment, the energy beam receiver 104 may be configured for receiving the focused energy beam 108 in a first form, such as a form having a first set of energy beam characteristics (e.g., corresponding to the characteristics of a beam of microwave energy). The energy beam receiver 104 may also be configured for converting the form of the received energy from the first form (i.e., as a beam of electromagnetic energy) to a second form, such as in the form of thermal energy, which may be used in accordance with further means for performing useful work.

In an exemplary embodiment, the energy beam receiver 104 includes a heat exchanger 112. The heat exchanger 112 may be configured and arranged for receiving and passing a stream of working fluid 114. In addition, the heat exchanger 112 may be configured for absorbing the electromagnetic energy (i.e., electromagnetic radiation) received from the focused energy beam 108 and for transferring the absorbed electromagnetic energy to the stream of working fluid 114 in the form of thermal energy. Accordingly, in an exemplary embodiment, the heat exchanger 112 may be configured to cause the thermal energy (i.e., enthalpy) contained in the stream of working fluid 114 to increase from a first energy level associated with the stream of working fluid 114, where the stream of working fluid 114 enters the heat exchanger 112, to a second energy level where the stream of working fluid 114 exits the heat exchanger 112. Thus, energy may be delivered to the heat exchanger 112 in the form of electromagnetic energy, may be transmitted to the working fluid 114 in the heat exchanger 112, and may be carried from the heat exchanger 112 by the working fluid 114 in the form of thermal energy.

The thermal energy carried by the stream of working fluid 114 may be used to perform useful work. For example, in one exemplary embodiment, the stream of working fluid 114 may be accelerated through an exhaust nozzle (not shown) so as to generate thrust. In another exemplary embodiment, the stream of working fluid 114 may be expanded as it is passed through a turbine (not shown) so as to produce output shaft power. In still another embodiment, the stream of working fluid 114 may be split such that a first portion of the stream of working fluid 114 may be expanded through a turbine so as to produce output shaft power while a second portion of the stream of working fluid 114 may be accelerated through an exhaust nozzle so as to generate thrust for accelerating the vehicle 110. The output shaft power may be used to drive a pump or compressor so as to motivate the working fluid 114 to flow through the heat exchanger 112. Still further, the stream of working fluid 114 may be circulated through or adjacent to other components so as to transfer thermal energy to those components as may be desired. Accordingly, the energy transfer system 100 may be useful in a variety of applications, including an external microwave propulsion thruster used to power an aerospace vehicle.

In an exemplary embodiment, the heat exchanger 112 comprises a body 116 that defines a path 113, through which the working fluid 114 flows. The body 116 includes an energy transmitting portion 118 and an energy reflecting portion 120. The energy transmitting portion 118 is positioned and configured so as to receive the focused energy beam 108 and to transmit the energy from the focused energy beam 108 to the working fluid 114 for absorption by the stream of working fluid 114 in the form of thermal energy. Accordingly, in an exemplary embodiment, the path 113 may be disposed approximately transversely to the focused energy beam 108, and the energy transmitting portion 118 is disposed so as to be positioned along the path 113, between the path 113 and the transmitter 103. Thus, as the focused energy beam 108 is received into the heat exchanger 112, may the focused energy beam 108 may be transmitted through the energy transmitting portion 118, directly to the working fluid 114 for absorption as heat energy.

The energy reflecting portion 120 is configured for reflecting electromagnetic energy and is disposed such that microwave energy that passes through the stream of working fluid 114 but is not absorbed as thermal energy may be reflected by the energy reflecting portion 120 so as to be passed through the stream of working fluid 114 one or more additional times. Thus, in an exemplary embodiment, the energy reflecting portion 120 is disposed so as to be positioned along the path 113, such that the path 113 is between the energy reflecting portion 120 and the transmitter 103. Thus, after the focused energy beam 108 passes through the stream of working fluid 114 passing through the path 113, any electromagnetic energy that is was not absorbed as heat by the stream of working fluid 114 may be reflected by the energy reflecting portion 120, through the working fluid 114, for absorption by the stream of working fluid 114 as heat energy. In an exemplary embodiment, the energy reflecting portion 120 may be arranged and configured so as to reflect some or all of the electromagnetic energy it receives back toward the transmitter 103. In another exemplary embodiment, the energy reflecting portion 120 may be arranged and configured so that a first section of the energy reflecting portion 120 may reflect some or all of the electromagnetic energy it receives toward another section of the energy reflecting portion 120 (e.g., through the stream of working fluid 114). Thus, electromagnetic energy that is received by the heat exchanger 112 may be caused to pass through the stream of working fluid 114 one or more times, thereby increasing the extent to which energy from the electromagnetic energy beam is absorbed as thermal energy by the stream of working fluid 114. In addition, in certain situations where doing so may be desirable, the electromagnetic energy that is received by the heat exchanger 112 may be reflected by the energy reflecting portion 120 so as to avoid passing through the stream of working fluid 114 and/or so as to be reflected and directed away from the heat exchanger 112 in one or more desired directions.

In a further exemplary embodiment, the energy reflecting portion 120 may be configured such that either the extent to which it reflects microwave energy and/or the direction or set of directions along which it reflects electromagnetic energy may be controlled. Similarly, in an exemplary embodiment, the energy transmitting portion 118 may be configured such that either the extent to which it transmits microwave energy may be controlled. Thus, the heat exchanger 112 may be configured so as to facilitate control over the extent to which the heat exchanger 112 allows the stream of working fluid 114 to absorb electromagnetic energy in the form of heat. In addition, the heat exchanger 112 may be configured so as to facilitate control over the extent to which, and the direction or set of directions in which, the heat exchanger 112 discharges electromagnetic energy.

In an exemplary embodiment, the heat exchanger 112 also includes a coating 122. The coating 122 may be disposed on the energy transmitting portion 118 so as to be disposed between the energy transmitting portion 118 and the transmitter 103. Accordingly, the coating 122 is disposed so as to face in an outward direction 124 that is aimed toward the incipient, focused energy beam 108 (e.g., facing in an outward direction 124 from the heat exchanger 112, toward the transmitter 103). Thus, in an exemplary embodiment, the coating 122 may be configured so as to transmit electromagnetic energy having the characteristics of the focused energy beam 108.

In an exemplary embodiment, the heat exchanger 112 also includes an insulating layer 126 configured and arranged so as to inhibit undesired transmission of thermal energy out of the heat exchanger 112 to heat sinks other than the working fluid 114. Thus, the insulating layer 126 may be disposed on the energy reflecting portion 120 so as to retain thermal energy within the heat exchanger 112 and prevent undesired transmission of heat through the energy reflecting portion 120 to adjacent structures. It should be appreciated that the heat exchanger 112 is thus configured and arranged (e.g., in or on a vehicle) so that the electromagnetic energy of the focused energy beam 108, which is transmitted toward the heat exchanger 112, first encounters the coating 122 disposed on the energy transmitting portion 118 of the heat exchanger 112.

In an exemplary embodiment, the body 116 comprises a ceramic matrix composite (CMC) material configured to improve mechanical/structural strength and reliability (i.e., mechanical robustness) of the heat exchanger 112. In an exemplary embodiment, the CMC material comprises structural fibers that are arranged and distributed so as to provide a heat exchanger 112 that exhibits structural strength similar to that of metal, with reduced weight, while also providing the ability to transmit (or, if desired, to absorb) electromagnetic energy (e.g., microwave energy) from the focused energy beam 108 and to thereby facilitate the absorption, by the stream of working fluid 114, of the electromagnetic energy in the form of thermal energy.

In an exemplary embodiment, the body 116 comprises a continuous phase (matrix) with a chemical composition that is adjusted so as to provide improved ability to absorb (and/or, as desired, to transmit and/or reflect) microwave energy from the focused energy beam 108. For example, in embodiments wherein the body 116 comprises a CMC material including silicon carbide fiber (distributed phase) and silicon carbide matrix, the matrix component may be doped with a quantity of dopant 136 configured to provide suitable ability to absorb microwave energy from the focused energy beam 108 considering the particular configuration of the heat exchanger 112 and the particular mode of operation.

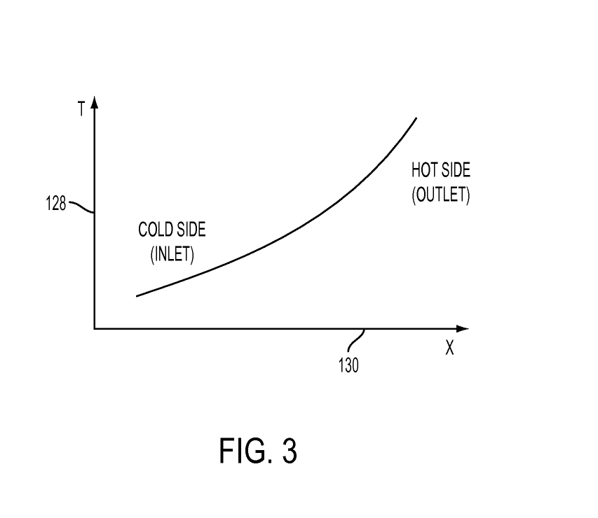

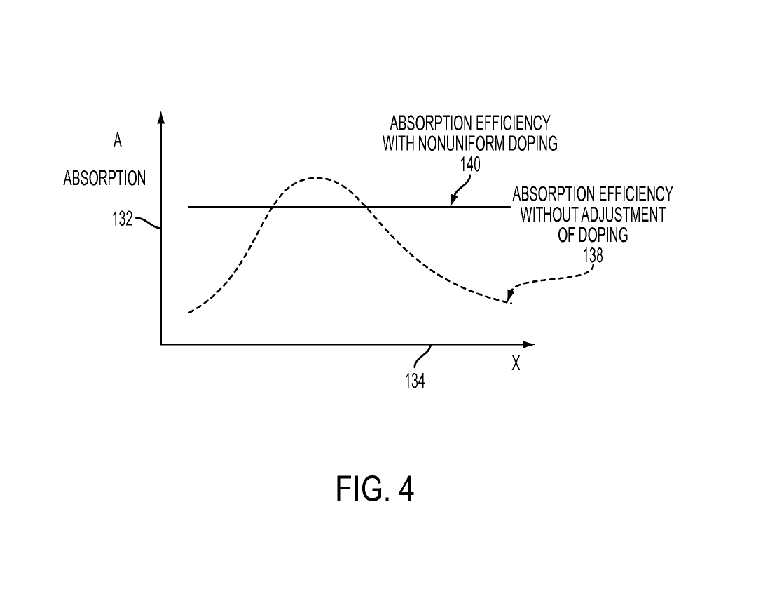

FIG. 3 shows an exemplary relationship between local temperature 128 and position 130 along the path 113 of the stream working fluid 114 within an exemplary heat exchanger 112. FIG. 4 shows exemplary relationships between energy absorption 132 and position 134 along the path 113 of the stream of working fluid 114 within an exemplary heat exchanger 112. In situations where an operating mode of a heat exchanger 112 (e.g., the maximum and minimum temperatures of the heat exchanger 112, the temperature distribution across the heat exchanger 112, and the amount/rate and distribution/profile of incident energy to which the heat exchanger 112 is to be exposed, etc.) is known or may otherwise be predicted, a profile of dopant 136 to be distributed across a matrix of positions 134 (e.g., along a length and/or width of the heat exchanger 112) across the heat exchanger 112 may be configured so as to advantageously provide a desirable distribution of performance attributes (e.g., absorptivity/transmissivity and/or reflectivity with respect to electromagnetic energy) across the heat exchanger 112 (i.e., along the path 113, and at various positions 134 relative to the path 113 and the transmitter 103). It should be appreciated that dopant may be introduced into the distributed phase via chemical vapor infiltration, melt infiltration, slurry, or any other process known in the art. Thus, as shown in FIG. 4, a profile of an absorption efficiency of an exemplary heat exchanger 112 may adjusted from a first profile 138 associated with no adjustment of the distribution of dopant to a second, more advantageous (e.g., more uniform) profile 140 associated with an adjusted (e.g., non-uniform) distribution of dopant.

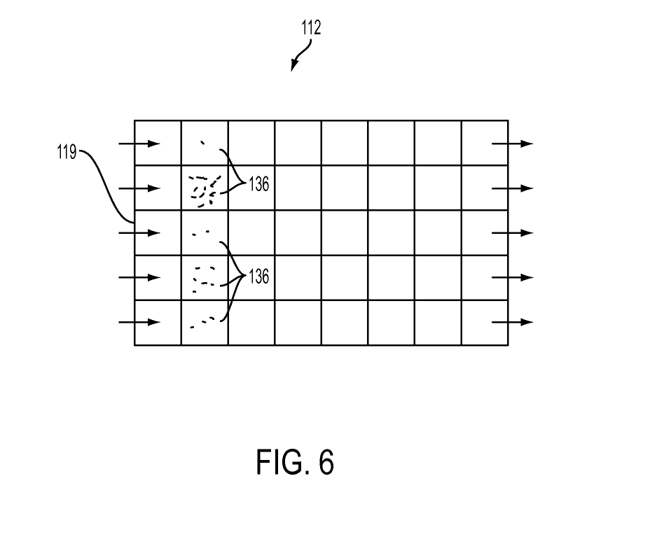

FIG. 6 shows a view of an exemplary heat exchanger 112 comprising a plurality of tiles arranged in a matrix configuration. In configurations where the heat exchanger 112 comprises a plurality of tiles 119 joined together, a quantity of dopant 136 within individual tiles 119 may be adjusted to provide suitable system performance. Such configurations may provide for production of relatively large heat exchangers or other components wherein application of dopant 136 to a single large component, such as a relatively large heat exchanger, would be more difficult or more costly or less reliable or otherwise disadvantageous relative to production of a larger quantity of smaller tiles to be joined or otherwise assembled to form a larger component exhibiting the desired characteristics. It should be appreciated that relatively smaller tiles may be manufactured in a more precisely controllable, less costly, more reliable environment. For example, it may be advantageous to produce tiles 119 having an overall dimension no larger than approximately about 40 centimeters in length and/or width. In such smaller tiles 119, it may be advantageous to dope each tile individually with a fixed quantity of dopant 136 rather than attempting to apply varying concentrations of dopant 136 within each individual tile or component.

In one embodiment, each individual (e.g., relatively small, such as, for example, measuring less than approximately 40 centimeters in length and/or width) tile or component may be doped uniformly within itself to produce a tile having a performance attribute that is substantially uniform, regardless of location on that tile. While tiles 119 may be uniform in performance within themselves, variations in performance may be produced among tiles 119, and tiles 119 with differing levels of dopant 136, and thus having different performance characteristics, may be selected and assembled to produce a relatively large component having a desirable performance profile (i.e., a non-uniform distribution of performance characteristics). For example, multi-tile configurations (exhibiting non-uniform performance characteristics) may be advantageously produced for components measuring at least about two meters in length and/or width.

In an exemplary embodiment, the coating 122 is configured to improve the efficiency of the heat exchange process. The coating 122 may be configured as a thin layer disposed so as to cover an external surface of the body 116. The coating 122 may be configured so as to improve the absorption, transmission, and/or reflection of electromagnetic energy (i.e., serving as anti-reflecting coating, a reflective coating, or a transmissive coating) and where the body 116 comprises a CMC material that is prone to oxidation (e.g., SiC-SiC CMC becomes oxidation unstable above 1650 C), to reduce the likelihood or severity of oxidation of the body 116. Thus, in an exemplary embodiment, the coating 122 is substantially transmissive (i.e., low loss) with respect to electromagnetic radiation, thermally insulative (i.e., low or very low in thermal conductivity) and resistant to oxidation (i.e., oxidation stable).

Furthermore, coating 122 may comprise a material that is electromagnetically active (i.e., a meta-material). In such embodiments, a pattern of small (i.e., having dimensions that are typically smaller that the wavelength of the incoming electromagnetic energy) meta-material elements may be embedded into the coating 122 deposited on selected portions of the heat exchanger 112. Such meta-material coatings may be configured to produce desirable electromagnetic absorption characteristics.

In an exemplary embodiment, the insulating layer 126 is disposed so as to resist conduction of thermal energy out of the heat exchanger 112. In an exemplary embodiment, the insulating layer 126 comprises an aerogel blanket. In another exemplary embodiment, the insulating layer 126 comprises an aerogel-filled foam such as a silicon carbide foam.

In an exemplary embodiment, the heat exchanger 112 is disposed adjacent to a cryogenic propellant tank. To reduce undesired transfer of thermal energy from the heat exchanger 112 to the cryogenic propellant tank, an insulating layer 126 is disposed between the heat exchanger 112 and the cryogenic propellant tank. In an exemplary embodiment, the insulating layer 126 is disposed on an external surface of the heat exchanger 112, the external surface being disposed adjacent to the cryogenic propellant tank. Thus, the insulating layer 126 is disposed and configured so as to prevent thermal energy from leaving the heat exchanger 112, and in particular, to prevent (or control the rate of) transfer of thermal energy from the heat exchanger 112 to the cryogenic propellant tank or any other adjacent component.

It should be appreciated that as electromagnetic energy from the focused energy beam 108 reaches the heat exchanger 112, it is desirable for the electromagnetic energy to be absorbed in an efficient manner. Exemplary embodiments disclosed herein provide a heat exchanger 112 that is capable of absorbing microwave energy and transferring the energy to the working fluid 114 in the form of thermal energy. Exemplary embodiments provide for improved energy/power transfer efficiency while enabling a wide range of applications (including aerospace applications). Exemplary embodiments disclosed herein provide a heat exchanger 112 that is able to facilitate absorption of microwave energy by a stream of working fluid 114, while being light in weight, mechanically robust, chemically stable, and thermally conductive.

The disclosed invention enables highly efficient transfer of electromagnetic energy from a remote source into thermal energy of a stream of working fluid flowing through the heat exchanger. The absorbed energy can be used to create thrust needed for propulsion or may otherwise be used for delivering heat to a desired location or otherwise for producing useful work. Thus the disclosed heat exchanger enables efficient operation of external microwave propulsion system in a manner that has not been feasible with heat exchangers known in the art.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A system for receiving inbound energy from an electromagnetic energy beam and for transferring the inbound energy to a working fluid as thermal energy, the system comprising:
a heat exchanger body that defines a path for the working fluid;
the heat exchanger body comprising a ceramic matrix composite material;
the ceramic matrix composite material being configured to exhibit a desired level of absorptivity or reflectivity with respect to the inbound energy.

2. The system of claim 1, wherein the ceramic matrix composite material comprises structural fibers.

3. The system of claim 2, wherein the structural fibers are arranged and distributed so as to provide structural strength similar to or exceeding a strength of aluminum.

4. The system of claim 2, wherein the structural fibers are arranged and distributed so as to provide structural strength similar to or exceeding a strength of steel.

5. The system of claim 1, wherein the ceramic matrix composite material is configured to absorb microwave energy from the electromagnetic energy beam.

6. The system of claim 5, wherein the electromagnetic energy beam is a microwave energy beam.

7. The system of claim 1, wherein the ceramic matrix composite material is a continuous phase matrix with a chemical composition configured to absorb energy from the electromagnetic energy beam.

8. The system of claim 3, wherein the ceramic matrix composite material includes silicon carbide fibers in a distributed phase so as to form a silicon carbide matrix.

9. The system of claim 8, further comprising a dopant distributed within the silicon carbide matrix, the dopant selected to facilitate absorption of energy from the electromagnetic energy beam.

10. The system of claim 9, wherein the dopant is selected to facilitate absorption of microwave energy from the electromagnetic energy beam.

11. The system of claim 1, wherein the heat exchanger body comprises a plurality of tiles joined together.

12. The system of claim 9, wherein the dopant is distributed within the silicon carbide matrix via chemical vapor infiltration.

13. The system of claim 9, wherein the dopant is distributed within the silicon carbide matrix via melt infiltration.

14. The system of claim 9, wherein the dopant is distributed within the silicon carbide matrix via a slurry process.

15. The system of claim 1, wherein the heat exchanger body comprises an energy transmitting portion positioned and configured so as to receive the inbound energy, to absorb microwave energy from the inbound energy, and to transfer the microwave energy to the working fluid as thermal energy.

16. The system of claim 15, further comprising a coating disposed on the energy transmitting portion so as to face in a direction toward the electromagnetic energy beam.

17. The system of claim 16, wherein the coating is configured as a thin layer disposed so as to cover an external surface of the heat exchanger body.

18. The system of claim 16, wherein the coating is configured so as to improve a rate of absorption of electromagnetic energy from the inbound energy.

19. The system of claim 16, wherein the coating is anti-reflective with respect to electromagnetic radiation.

20. The system of claim 16, wherein the coating is anti-reflective with respect to microwave radiation.

21. The system of claim 16, wherein the coating is substantially transmissive with respect to electromagnetic radiation.

22. The system of claim 21, wherein the coating is substantially transmissive with respect to microwave radiation.

23. The system of claim 16, wherein the coating is thermally insulative.

24. The system of claim 16, wherein the coating is resistant to oxidation.

25. The system of claim 1, wherein the heat exchanger body comprises an energy reflecting portion disposed and configured so as to retain thermal energy within the heat exchanger body.

26. The system of claim 25, wherein the energy reflecting portion comprises an insulating layer.

27. The system of claim 26, wherein the insulating layer is disposed so as to resist conduction of thermal energy.

28. The system of claim 26, wherein the insulating layer comprises an aerogel blanket.

29. The system of claim 26, wherein the insulating layer comprises an aerogel-filled foam.

30. The system of claim 29, wherein the insulating layer comprises silicon carbide.

31. The system of claim 26, wherein the insulating layer is disposed between the heat exchanger body and a cryogenic propellant tank.

32. A method for configuring a heat exchanger for receiving inbound energy from an electromagnetic energy beam and for transferring the inbound energy to a working fluid as thermal energy, the method comprising:
providing a heat exchanger body that defines a path for the working fluid, the heat exchanger body comprising a ceramic matrix composite material that comprises a SiC matrix; and
introducing a dopant into the SiC matrix;
wherein the dopant is selected to facilitate absorption of energy from the electromagnetic energy beam; and
wherein the dopant has a concentration that is suitable to achieve a desired rate of energy absorption from the electromagnetic energy beam.

33. The method of claim 32, wherein the introducing is performed via chemical vapor infiltration.

34. The method of claim 32, wherein the introducing is performed via melt infiltration.

35. The method of claim 32, wherein the introducing is performed via a slurry process.
